(19) United States
(12) Patent Application Publication
(10) Pub. No.: US 2007/0136688 A1
(43) Pub. Date: Jun. 14, 2007

(54) Method for predictive text input in devices with reduced keypads

(76) Inventors: Eugene A. Mirkin, Cupertino, CA (US); Jason C. Simon, Campbell, CA (US)

Correspondence Address: MOTOROLA INC, 600 NORTH US HIGHWAY 45, ROOM AS437, LIBERTYVILLE, IL, 60048-5343, US

(21) Appl. No.: 11/299,157

(22) Filed: Dec. 8, 2005

(51) Int. Cl. G06F 17/00

(52) U.S. Cl. 715/816

(57) ABSTRACT

A method of inputting text in an electronic device (201) including a display (203) and an input user interface (202) having a plurality of keys (210) arranged in a predetermined pattern includes a plurality of steps. In a first step, a list of potential characters is compiled and includes at least one subset less than or equal in number to the number of keys in the keypad matrix (207) on the input user interface (202). The first subset from the list of potential characters is displayed in an arrangement corresponding to the position of the keys (207). The desired character selection is received by sensing actuation of a key on the input user interface (202) corresponding to the position of a character on the display (203).

### FIELD OF THE DISCLOSURE

The present invention relates generally to the entry of text into a device having a relatively small input user interface.

### BACKGROUND OF THE DISCLOSURE

Short message service, also known as text messaging, has become a widely-used mode of communication. In general, text messaging refers to a service available on mobile devices that permits the sending and receiving of short messages. The use of text messaging has grown enormously, and it is presently estimated that 500 billion text messages are sent per annum. Mobile devices used in text messaging typically have relatively small input user interfaces, often provided as keypads having a 3×4 (3 columns and 4 rows) matrix layout. Because of the limited message lengths and tiny user interface of mobile devices, text message users commonly make extensive use of abbreviations, particularly the use of numbers for words (for example, “4” in place of the word “for”), the omission of vowels, as in the phrase “txt msg”, or the replacement of spaces with capitalization, such as “ThisIsVeryCool”.

In addition to abbreviations and creative grammatic structures, input methods have been developed to facilitate text messaging. Currently, there are two common input method types: “multitap”, where the user presses a button several times until the correct character is presented; and “predictive”, where a predictive system (e.g., iTAP) determines the best way to disambiguate keypresses and offers a likely word. Although they provide advantages, known input methods present problems of their own. For example, multitap requires an excessive number of keypresses. Predictive input often suggests a word other than that desired by the user, causing the user to delete the string and start over, resulting in additional input overhead.

### BRIEF DESCRIPTION OF THE DRAWING

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a flow chart illustrating a method in accordance with some embodiments.

FIG. 2 is an example of an electronic device displaying a first text screen in accordance with some embodiments.

FIG. 3 is an example of an electronic device displaying a second text screen in accordance with some embodiments.

FIG. 4 is an example of an electronic device displaying a third text screen in accordance with some embodiments.

FIG. 5 is an example of an electronic device displaying a fourth text screen in accordance with some embodiments.

FIG. 6 is an example of an electronic device displaying a fifth text screen in accordance with some embodiments.

FIG. 7 is an example of an electronic device displaying a sixth text screen in accordance with some embodiments.

FIG. 8 is an example of an electronic device displaying a seventh text screen in accordance with some embodiments.

FIG. 9 is an example of an electronic device displaying an eighth text screen in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail embodiments that are in accordance with the present invention, it should be observed that the embodiments reside primarily in combinations of method steps and apparatus components related to the entry of text into a device having a relatively small input user interface. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

A method of inputting text in an electronic device including a display and an input user interface having a plurality of keys arranged in a predetermined pattern includes a plurality of steps. In a first step, a list of potential characters is compiled and includes at least one subset less than or equal in number to the number of keys in the keypad matrix on the input user interface. The first subset from the list of potential characters is displayed in an arrangement corresponding to the position of the keys. The desired character selection is received by sensing actuation of a key on the input user interface corresponding to the position of a character on the display. Additional subsets can be presented if the desired character is not shown in the first subset. By displaying subsets in a pattern corresponding to the key positions, a user can quickly find a desired character on the display and actuate the corresponding key to select the desired character.

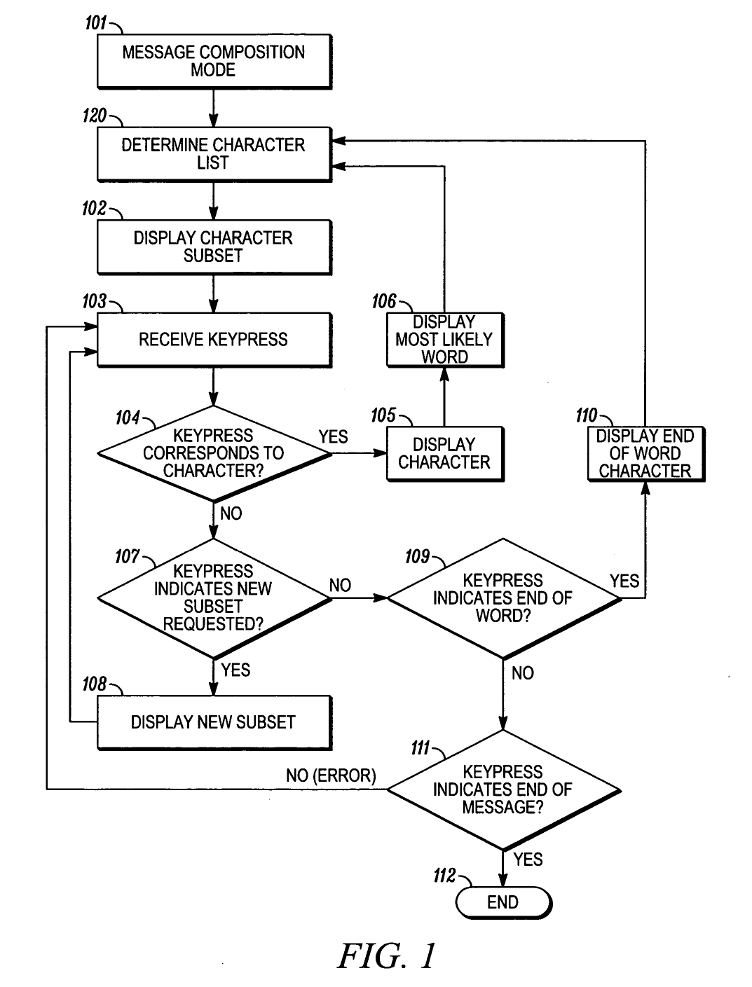

A method of inputting text into an electronic device with a reduced keypad is shown in FIG. 1. Although this method was originally developed for text messaging on a mobile station (also called a cellular telephone or user equipment), this method can be implemented on electronic toys, landline telephones, remote controllers, video or arcade games, and other electronic devices having reduced keypads. In such electronic devices, the keypad is said to be “reduced” in that the number of keys is considerably smaller in number than a set of potentially desired characters.

In a first step 101, an electronic device is in a text entry or message composition/reply mode, as is typical when a user of the device activates a text messaging routine or program in the particular device. At step 120, the mobile device determines a list of alphanumeric characters. The character list is determined either statically or dynamically, and a subset is taken from the list to present on a user interface display in step 102. An example of a static list would be the entire Roman alphabet in alphabetical order followed by the numbers 0-9 in numerical order followed by punctuation marks in a predetermined order. Other static lists can be compiled for both Roman character and non-Roman character alphanumeric text entry. An example of a dynamic list would be predictive (probability-based) subsequent characters based on previously entered characters in a word or a message. Each subset presented in step 102 may be arranged on the user interface display so that the predictive subsequent characters are in descending order of likelihood of selection. Alternately, each subset presented in step 102 may be arranged on the user interface display in alphabetical order—but only those letters that are of similar probability according to the dynamic list.

Each pass through step 120 could be either static or dynamic. For example, if there were no previously-entered characters in a message, a first pass through step 120 could determine a full-alphabet, static list. Then, after a first letter of a message was entered, a second pass through step 120 could determine a predictive, dynamic list. Conversely, a first pass through step 120 could determine a predictive, dynamic list that has high probabilities for a first letter of a salutation (e.g., “H” for “Hi” and “Hello”) while subsequent passes could determine a full-alphabet, static list. Alternately, each pass through step 120 could determine a static list. Still another alternate embodiment would have each pass through step 120 determine a dynamic list. Note also, a variation of a dynamically-determined list where the first few (e.g., nine) entries are the most likely characters followed by a full-alphabet in a predetermined order. Thus, the first subset would seem to be from a dynamic list and subsequent subsets would seem to be from a static list as will be evident from further explanation.

At the first pass through step 102, the mobile device will display an initial list or subset of characters corresponding in number and arrangement to at least a portion of the input user interface of the electronic device. Next, at step 103, the electronic device receives a keypress from the user. If at step 104 the sensed actuation of a key corresponds to a character in the step 103 subset, the character is displayed at step 105. The electronic device uses the algorithm to determine the most likely word having that character (and any preceding characters), displays the word itself on an input line of the user interface display at step 106, and returns to step 120 to determine a next character list. The following characters in a most likely word can be displayed after the text entry cursor. In one embodiment the following characters are displayed in a lighter (less bright) text than the positively entered characters, and the input cursor is positioned right after the entered characters and before the lighter characters. Alternately, the following characters in a most likely word can be displayed using a different color, in italics text, with a dashed underline, or using another mechanism to distinguish the positively entered characters from the following characters in a most likely word.

If the step 104 keypress does not correspond to a character, the electronic device determines if the keypress indicates that a new subset of characters is needed at step 107. If so, an alternative subset is displayed at step 108, and the process returns to step 103 to await a new keypress. Alternate subsets are created by displaying the next group of characters from the list determined in step 120. For example, a first nine-character subset of a full-alphabet, static list is the letters A-I. A next nine-character subset of the full-alphabet, static list is the letters J-R. A further nine-character subset of the full-alphabet, static list is the letters S-Z followed by a blank entry for the ninth character of the subset. Still further nine-character subsets can cycle through the entire list again starting with A-I. Of course, each subset can have greater than or fewer than nine characters, depending on the arrangement of the input user interface of a particular electronic device.

If it is determined at step 107 that the step 104 keypress does not request a new subset, the electronic device next determines if the keypress indicates the end of a word at step 109. Common end-of-word keypresses include spaces, commas, periods, other punctuation marks, and carriage returns. These keypresses can be implemented as special function keys or as characters available from the displayed subset. If the keypress indicates the end of a word, the indicated end-of-word character (e.g., space, comma, period, other punctuation mark, etc.) is displayed on the input line of the user interface display at step 110, and the electronic device returns to step 120 to determine a new list of characters.

If the step 104 keypress does not indicate the end of a word at step 109, the electronic device determines if the keypress indicates the end of the message at step 111. If so, the message composition process ends at step 112. If, at step 111, the step 104 keypress is determined to have been something other than a character, end of word, or end of message, an error has occurred and the process returns to step 103 to obtain the next keypress.

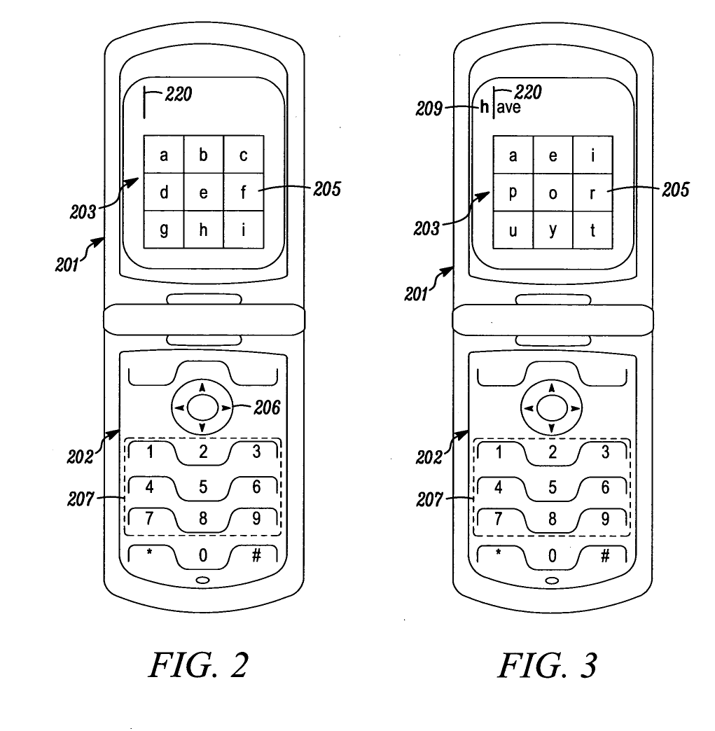

An example of a method and apparatus for predictive text input is illustrated in FIGS. 2-9. In this example, the user desires to input the word “hello” into an electronic device 201 that includes an input user interface 202 with keys 210 and a cursor controller 206, as well as a display 203, as shown in FIG. 2. The input user interface 202 can also include a microphone, a touchpad, a scroll wheel, and/or other input elements. The electronic device is shown as a mobile station (also called a cellular telephone or user equipment); however, the electronic device 201 could easily be an electronic toy, landline telephone, remote controller, video or arcade game, or another electronic device having a reduced keypad. The user has actuated a text entry program on the electronic device 201. The display 203 shows a 3×3 matrix 205 of alphanumeric characters, corresponding to a pattern of the top three rows of the 3×3 matrix 207 of keys 210 on the input user interface 202. In this example, the electronic device 201 uses a full-alphabet static list for the first character in any word, thus the first nine-character subset presented has the letters A-I in alphabetical order. In order to select a desired letter, the user presses the key corresponding in position to the desired letter shown on the display 203. In this example, the desired letter, “h”, is located in the third row, second column of the display matrix 205, and the correspondingly-located key, “8”, is located in the third row, second column of the keypad matrix 207. Thus, the letter “h” is entered by actuating the correspondingly located key, “8”. The electronic device displays the letter “h” in an input line 209 of the user interface display 203 (FIG. 3).

The electronic device 201 uses an algorithm to determine the word most likely to be desired given the input of the letter “h”, and displays the word in the input line 209 of the user interface display 203. In this example, the word “have” is shown with the “h” 1 5 being darker (or brighter, depending on the display technology) followed by the input cursor 220 and then the remainder of the most likely word “ave” being lighter or in a different color or text style.

After the first character of a word has been entered, in this example the electronic device 201 uses a predictive algorithm to determine a dynamic list using the variation of a dynamically-determined list described earlier. The electronic device uses the algorithm to determine a list having the top nine alphanumeric characters most likely to follow the “h” followed by a full alphabet in alphabetical order. The device next divides the list into subsets and displays a first subset, as shown in FIG. 3. The desired letter, “e”, is entered by actuating the correspondingly located key, “l”. The letter “e” is added to the “h” on the input line 209 of the user interface display 203, along with the most likely word incorporating the starting string “he”, and in this example, the word “her” is shown with the input cursor 220 following the positively entered character string “he” and the remainder of the most likely word “r” being in lighter text.

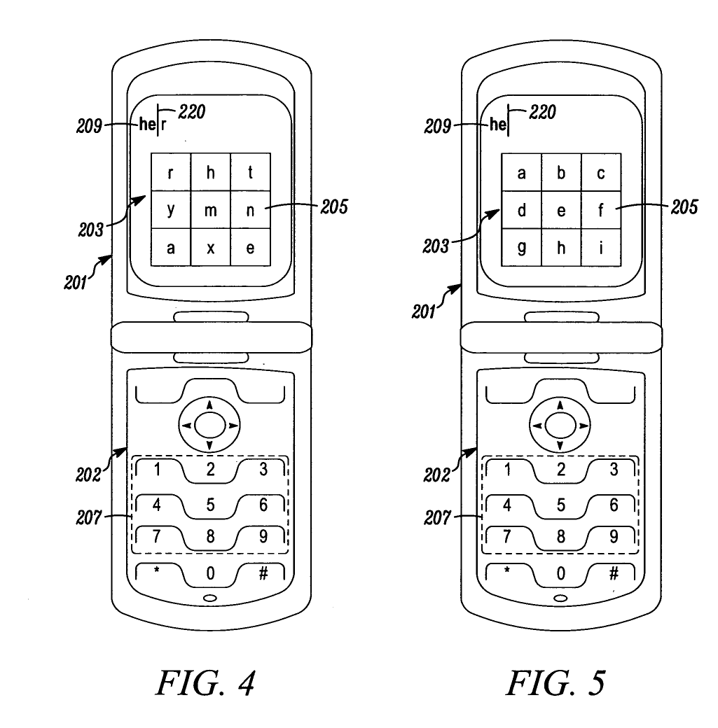

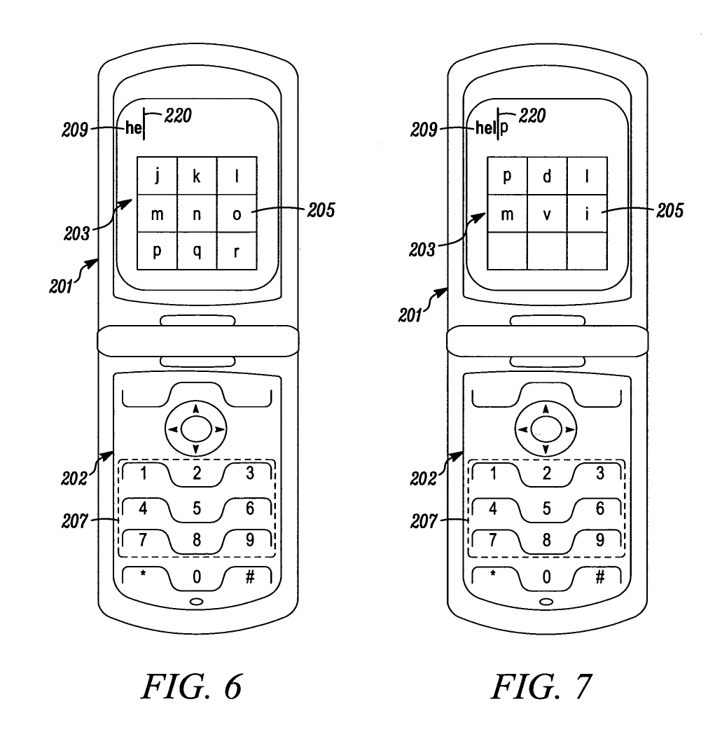

The electronic device further uses the algorithm to determine a list with the top nine alphanumeric characters most likely to follow the string “he”, followed by a full alphabet, divides the list into subsets, and displays another first subset, as shown in FIG. 4. In this example, the desired letter, “l”, is not present on the displayed first subset. The user rejects the FIG. 4 subset by pressing the “#” key without selecting an alphanumeric character from the displayed subset. In this example, the “#” key is used as a function key to advance to the next subset. However, it is to be understood that other keys could be used as function keys, including one or more soft keys or cursor control keys. In response, the electronic device displays a subsequent subset in FIG. 5, here shown as a listing of characters in alphabetical order. Again, the desired character is not present in the displayed subset, and the function “subset advance” key is pressed without selecting a character. In response, the electronic device displays another subsequent subset as shown in FIG. 6. The desired letter, “l”, is present, and is entered by actuating the correspondingly located key, “3”. The letter “l” is appended to the string, “he,” in the input line 209 of the user interface display 203, and “help” is displayed as the most likely word given input of the string “hel”.

The electronic device next uses the predictive algorithm to dynamically determine the ordered list of top nine alphanumeric characters most likely to follow the string “hel” followed by a full alphabet, divides the list into subsets, and displays a first subset, as shown in FIG. 7. Here, the number of characters present in the first subset is smaller than the number of available positions in the nine-character pattern. The desired letter, “l”, is entered by actuating the correspondingly positioned key, “3”. A second “l” is appended to the string “hel” in the input line 209 of the user interface display 203, and “hello” is displayed as the most likely word given input of the string “hell”.

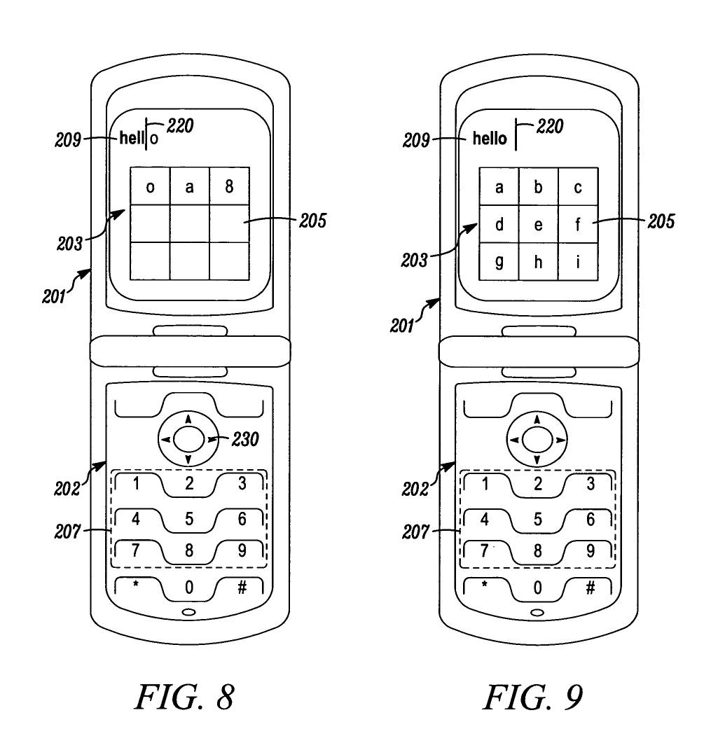

The electronic device again uses the predictive algorithm to determine the ordered list of alphanumeric characters most likely to follow the string “hell”, and displays a first subset, as shown in FIG. 8. Again, the number of characters present in the first subset is smaller than the number of available positions in the nine-character pattern. The desired letter, “o”, is entered by actuating the correspondingly located key, “l”. With the desired character string completed as shown in FIG. 9, a function key indicating the end of a word, here the “*” key, is pressed, and a space is displayed at the end of the word “hello”. Alternatively, because in this example, “hello” is the desired word, the user can employ a “quick complete” feature if the electronic device is so equipped. A quick complete feature permits selection of a suggested word (shown in FIG. 8) by pressing a function key, for example, the right cursor key 230 on the cursor controller 206 to command entry of the suggested word. Once the end of a word is indicated, the user can start another word, or end the message composition mode via a function key. The message can then be saved or sent as desired.

Note that dynamically-determined lists can “learn” words or abbreviations commonly employed by the user in order to minimize occurrences where the user requests further subsets. On the other hand, statically-determined lists have the benefit of being quickly internalized by a user. For example, a letter “y” in a full-alphabet static list will always be entered by using the keypress sequence ##7 with the examples above. The hybrid dynamically-determined list that has a first subset of most likely characters followed by subsets of full-alphabet alphabetic order characters is a compromise between the fully-dynamic lists and the fully-static lists.

Thus, it should be clear from the preceding disclosure that the illustrated method gives the user complete control over which character to pick, a characteristic that is available in multitap approaches but absent in iTAP. At the same time, the illustrated method displays the most likely desired alphanumeric characters first, as is available through iTAP but absent in multitap. The result is a method of predictive text input that offers many of the advantages of known systems while minimizing or eliminating their drawbacks.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the entry of text into a device having a relatively small input user interface described herein. The non-processor circuits may include, but are not limited to, a radio receiver, a radio transmitter, signal drivers, clock circuits, power source circuits, and user input devices. As such, these functions may be interpreted as steps of a method to perform the entry of text into a device having a relatively small input user interface. Alternatively, some or all functions could be implemented by a state machine having a relatively small input user interface that has no stored program instructions, or in one or more application specific integrated circuits (ASICs), in which each function or some combinations of certain of the functions are implemented as custom logic. Of course, a combination of the two approaches could be used. Thus, methods and arrangements for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. In an electronic device including a display and an input user interface having a plurality of character keys arranged in a predetermined pattern and at least one function key, a method of inputting text comprising:
determining a list of potential characters, the list including at least one subset less than or equal in number to a number of keys on the input user interface;
displaying a first subset from the list of potential characters on the display in an arrangement corresponding to a pattern of at least a portion of the plurality of character keys; and
receiving a desired character selection by sensing actuation of a character key corresponding to a position of a desired character of the first subset from the list of potential characters on the display.

2. A method according to claim 1, wherein the input user interface comprises a 1-9 button layout, and displaying a first subset further comprises displaying a subset of characters corresponding in pattern to the 1-9 button layout.

3. A method according to claim 2, wherein displaying a subset of characters corresponding in pattern to the 1-9 button layout comprises displaying a first subset of characters in a 3×3 matrix layout.

4. A method according to claim 1, wherein receiving a desired character selection comprises receiving a selection indicative of rejecting the first subset.

5. A method in accordance with claim 4, wherein receiving a desired character selection further comprises displaying an alternative subset after receiving a selection indicative of rejecting the first subset.

6. A method in accordance with claim 5, wherein receiving a desired character selection further comprises selecting a desired character from the alternative subset.

7. A method in accordance with claim 5, wherein displaying an alternative subset comprises displaying a list of characters arranged in a predetermined order.

8. A method in accordance with claim 1, further comprising:
after receiving a desired character selection, determining a list of potential following characters by using an algorithm to predict the characters most likely to follow the desired character selection, the list of potential following characters including at least one subset less than or equal in number to the number of keys on the input user interface;
displaying a first subset from the list of potential following characters on the display in an arrangement corresponding to the pattern of at least a portion of the plurality of character keys; and
receiving a desired following character selection by sensing actuation of a character key corresponding to a position of a desired following character of the first subset from the list of potential following characters on the display.

9. A method in accordance with claim 1, wherein determining a list of potential characters is preceded by displaying an initial character.

10. A method in accordance with claim 9, further comprising displaying the initial character and the desired character on the display of the electronic device.

11. A method in accordance with claim 9, further comprising:
determining a word statistically most likely to incorporate the initial character and the desired character; and
displaying the word on the display of the electronic device as a suggested word.

12. A method in accordance with claim 11, further comprising receiving a command to enter the suggested word by sensing actuation of a function key.

13. A method in accordance with claim 1, wherein displaying a first subset from the list of potential characters further comprises displaying characters in a predetermined order.

14. A method in accordance with claim 13, further comprising displaying an alternative subset of characters in response to actuation of a function key on the input user interface.

15. A method in accordance with claim 1, wherein displaying a first subset from the list of potential characters further comprises displaying potential characters in descending order of likelihood of selection.

16. A method in accordance with claim 1, wherein receiving a desired character selection comprises receiving a keypress indicating an end of a word.

17. A method in accordance with claim 16, further comprising repeating the determining a list of potential characters, the displaying a first subset from the list of potential characters, and the receiving a desired character selection.

18. A method in accordance with claim 16, wherein receiving a desired character selection comprises receiving a keypress indicating an end of a message.

19. A method in accordance with claim 18, further comprising storing the message.

20. A method in accordance with claim 18, further comprising sending the message.
